(19) United States
(12) Patent Application Publication
(10) Pub. No.: US 2020/0407545 A1
(43) Pub. Date: Dec. 31, 2020

(54) CURABLE RESIN COMPOSITION AND CURED PRODUCT

(71) Applicant: TOKYO OHKA KOGYO CO., LTD., Kawasaki-shi (JP)

(72) Inventors: Takehiro SESHIMO, Kawasaki-shi (JP); Hiroaki TAKEUCHI, Kawasaki-shi (JP); Tomoyuki INOUE, Kawasaki-shi (JP)

(21) Appl. No.: 16/896,589

(22) Filed: Jun. 9, 2020

(30) Foreign Application Priority Data
Jun. 28, 2019 (JP) 2019-122246

(51) Int. Cl. C08L 33/10

(52) U.S. Cl. CPC C08L 33/10; C08L 2207/53

(57) ABSTRACT

A curable resin composition capable of achieving a low refractive material having high solvent resistance. The curable resin composition includes a resin having two types of specific structural units, hollow particles including a shell portion made of a resin, and an organic solvent. The average particle diameter of the hollow particles may be 20 nm or more and 300 nm or less. The content rate of the resin in total solid content in the curable resin composition may be 30% by mass or more and 90% by mass or less.

This application claims priority to Japanese Patent Application No. 2019-122246, filed Jun. 28, 2019, the entire content of which is incorporated herein by reference.

### BACKGROUND OF THE INVENTION

### Field of the Invention

The present invention relates to a curable resin composition and a cured product.

### Related Art

Conventionally, as resin materials, materials having appropriately adjusted refractive indexes have been known, and such materials have been used in the field of optics and the like. For example, Patent Document 1 discloses a coating composition including a fluorine-containing curable compound having a specific structure, in addition to an oxetane compound and an epoxy compound. It is said that such a composition can form a low refractive index layer having excellent adhesion to a base material and mechanical strength.

Furthermore, particles (hollow silica) having a shell portion made of silica and an air gap inside have been known conventionally as means for achieving low refractive index materials (see, for example, Patent Document 2). In recent years, in order to achieve low refractive index materials as described above, hollow particles using an organic material (resin) for a shell as shown in Patent Documents 3 and 4 have also attracted attention. Such hollow particles are lighter than hollow silica, and are anticipated to have an affinity with a binder resin, so that they can be expected to be used in various applications.

Patent Document 1: Japanese Unexamined Patent Application, Publication No. 2005-316415

Patent Document 2: Japanese Unexamined Patent Application, Publication No. 2009-108155

Patent Document 3: Pamphlet of PCT International Publication No. WO2018/051794

Patent Document 4: Pamphlet of PCT International Publication No. WO2017/163439

### SUMMARY OF THE INVENTION

In forming an optical member, in one method, a low refractive index layer is formed, and then layers having different refractive indices are laminated on the low refractive index layer. Such a laminating process is carried out by separately spreading varnish and the like onto a low refractive index layer, the varnish being obtained by dissolving a resin material in an organic solvent. However, there are concerns that if the above-described low refractive index layer does not have resistance to the organic solvent, the film thickness of the low refractive index layer cannot be secured, or the desired refractive index cannot be achieved.

The present invention has been made in view of the above problems, and an object of the present invention is to provide a curable resin composition capable of achieving a low refractive material having high solvent resistance.

The present inventors have found that the above problems can be solved by using a resin including a resin having a specific structure and specific hollow particles in combination, and have completed the present invention.

A first aspect of the present invention is a curable resin composition including:

an (A) resin including a structural unit represented by the following formula (a1), and a structural unit represented by the following formula (a2);
(B) hollow particles including a shell portion made of a resin; and
an (S) organic solvent.

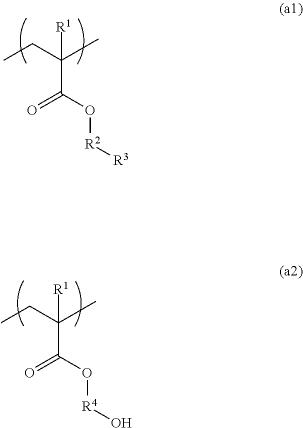

(In the formulae (a1) and (a2), R¹ each independently is a hydrogen atom, or a methyl group, R² is a single bond, or an alkylene group having 1 or more and 5 or less carbon atoms, R³ is a monovalent organic group having 2 or more and 30 or less carbon atoms including an epoxy group in a structure thereof, and R⁴ is a divalent hydrocarbon group).

A second aspect of the present invention is a cured product obtained by curing the curable resin composition according to the first aspect.

The present invention can provide a curable resin composition capable of achieving a low refractive material having high solvent resistance.

### DETAILED DESCRIPTION OF THE INVENTION

Hereinafter, the present invention is described based on the embodiments. Furthermore, in this specification, (meth)acrylate is a generic term for acrylate and methacrylate, and (meth)acrylic acid is a generic term for acrylic acid and methacrylic acid.

### <<Curable Resin Composition>>

A curable resin composition of this embodiment includes a component (A), a component (B), and a component (S), mentioned below, as essential components:

an (A) resin including a structural unit represented by the following formula (a1), and a structural unit represented by the following formula (a2)
(B) hollow particles including a shell portion made of a resin, and
an (S) organic solvent.

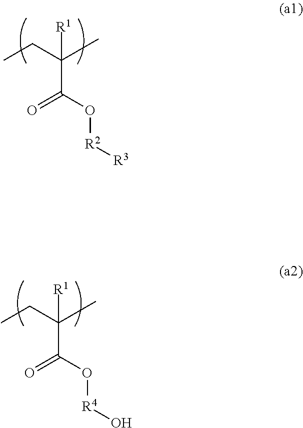

(In the formulae (a1) and (a2), R¹ each independently is a hydrogen atom, or a methyl group, R² is a single bond, or an alkylene group having 1 or more and 5 or less carbon atoms, R³ is a monovalent organic group having 2 or more and 30 or less carbon atoms including an epoxy group in a structure thereof, and R⁴ is a divalent hydrocarbon group).

The curable resin composition of this embodiment can express high solvent resistance (chemical resistance) in a cured product. The reason for this is not clear, but one reason is thought to be because when the (A) resin described above is applied, the (A) resin has high affinity with the resin constituting a shell of the (B) hollow particles, and forms a dense matrix when being cured. Hereinafter, essential components and optional components included in the curable resin composition of this embodiment will continue to be described.

### <<(A) Resin>>

(A) Resin includes a structural unit represented by the following formula (a1) and a structural unit represented by the following formula (a2).

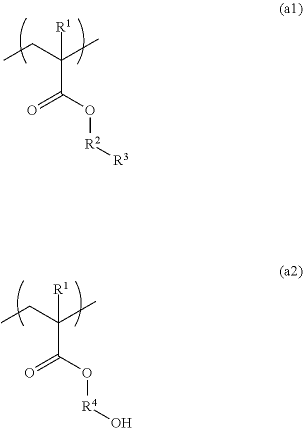

(In the formulae (a1) and (a2), R¹ each independently is a hydrogen atom, or a methyl group, R² is a single bond, or an alkylene group having 1 or more and 5 or less carbon atoms, R³ is a monovalent organic group having 2 or more and 30 or less carbon atoms including an epoxy group in a structure thereof, and R⁴ is a divalent hydrocarbon group).

Hereinafter, the structural unit represented by the formula (a1) is also referred to as a “structural unit A1”, and the structural unit represented by the formula (a2) is also referred to as a “structural unit A2”.

### <Structural Unit A1>

A structural unit A1 represented by the above formula (a1) includes an epoxy group in R³, thereby expressing curability as a resin.

The number of carbon atoms of an alkylene group usable as R² is 1 or more and 5 or less, preferably 1 or more and 4 or less, more preferably 1 or more and 3 or less, and further preferably 1 or 2. Specific examples of the alkylene group include a methylene group, an ethylene group, a propylene group, a butylene group, and the like.

R³ is a monovalent organic group having 2 or more and 30 or less carbon atoms including an epoxy group in a structure thereof. The organic group includes, for example, a hydrocarbon group optionally including a hetero atom such as an oxygen atom. The hydrocarbon group may be an aliphatic hydrocarbon group, or an aromatic hydrocarbon group. A structure of the aliphatic hydrocarbon group may be linear or branched or cyclic, or a combination thereof, and is preferably linear or cyclic. Examples of the linear group include an alkyl group, an alkoxyalkyl group, and the like. Examples of the cyclic group include a cycloalkyl group, and the like. The epoxy group includes not only a group represented by —CHCH₂O having a 3-membered ring in which one hydrogen atom is removed from ethylene oxide or oxirane (in this specification, also referred to as a “chain aliphatic epoxy group”), but also alicyclic epoxy groups other than these, and R³ may include a hetero atom and a halogen atom other than an oxygen atom constituting an epoxy group in a structure thereof. The hetero atom includes a nitrogen atom, a sulfur atom, a silicon atom, and the like, and examples of the halogen atom include a fluorine atom, a chlorine atom, a bromine atom, and an iodine atom.

The structural unit A1 can be formed, for example, by subjecting (meth)acrylic acid ester having an epoxy group to a polymerization reaction. The (meth)acrylic acid ester having an epoxy group may be either (meth)acrylic acid ester having a chain aliphatic epoxy group, or (meth)acrylic acid ester having an alicyclic epoxy group as mentioned below. The (meth)acrylic acid ester having an epoxy group may have an aromatic group. The (meth)acrylic acid ester having an epoxy group is preferably an aliphatic (meth)acrylic acid ester having a chain aliphatic epoxy group or an aliphatic (meth)acrylic acid ester having an alicyclic epoxy group. Note here that the structural unit A1 may be present in a resin in the form of a block or at random.

Examples of the (meth)acrylic acid ester including an aromatic group and having an epoxy group include 4-glycidyloxyphenyl (meth)acrylate, 3-glycidyloxyphenyl (meth)acrylate, 2-glycidyloxyphenyl (meth)acrylate, 4-glycidyloxyphenylmethyl (meth)acrylate, 3-glycidyloxyphenylmethyl (meth)acrylate, and 2-glycidyloxyphenylmethyl (meth)acrylate.

Examples of the aliphatic (meth)acrylic acid ester having a chain aliphatic epoxy group include (meth)acrylic acid esters in which a chain aliphatic epoxy group is bonded to an oxy group (—O—) in an ester group (—O—CO—), such as epoxyalkyl (meth)acrylate and epoxyalkyloxyalkyl (meth)acrylate. Such a chain aliphatic epoxy group of the (meth)acrylic acid ester may have one or a plurality of oxy groups (—O—) in a chain. The number of carbon atoms of the chain aliphatic epoxy group is not particularly limited, but is preferably 3 or more and 20 or less, more preferably 3 or more and 15 or less, and particularly preferably 3 or more and 10 or less.

Specific examples of the aliphatic (meth)acrylic acid ester having a chain aliphatic epoxy group include epoxyalkyl (meth)acrylates such as glycidyl (meth)acrylate, 2-methyl glycidyl (meth)acrylate, 3,4-epoxybutyl (meth)acrylate, and 6,7-epoxyheptyl (meth)acrylate; and epoxyalkyloxyalkyl (meth)acrylates such as 2-glycidyloxyethyl (meth)acrylate, 3-glycidyloxy-n-propyl (meth)acrylate, 4-glycidyloxy-n-butyl (meth)acrylate, 5-glycidyloxy-n-hexyl (meth)acrylate, and 6-glycidyloxy-n-hexyl (meth)acrylate.

Specific examples of the aliphatic (meth)acrylic acid ester having an alicyclic epoxy group include compounds represented by the following formulae (a1-1) to (a1-15). Of these compounds, compounds represented by the following formulae (a1-1) to (a1-5) are preferable, and compounds represented by the following formulae (a1-1) to (a1-3) are more preferable. Furthermore, regarding each of these compounds, the bonding site of an oxygen atom of an ester group to an alicyclic ring is not necessarily limited to the position shown herein, and may partially include a position isomer.

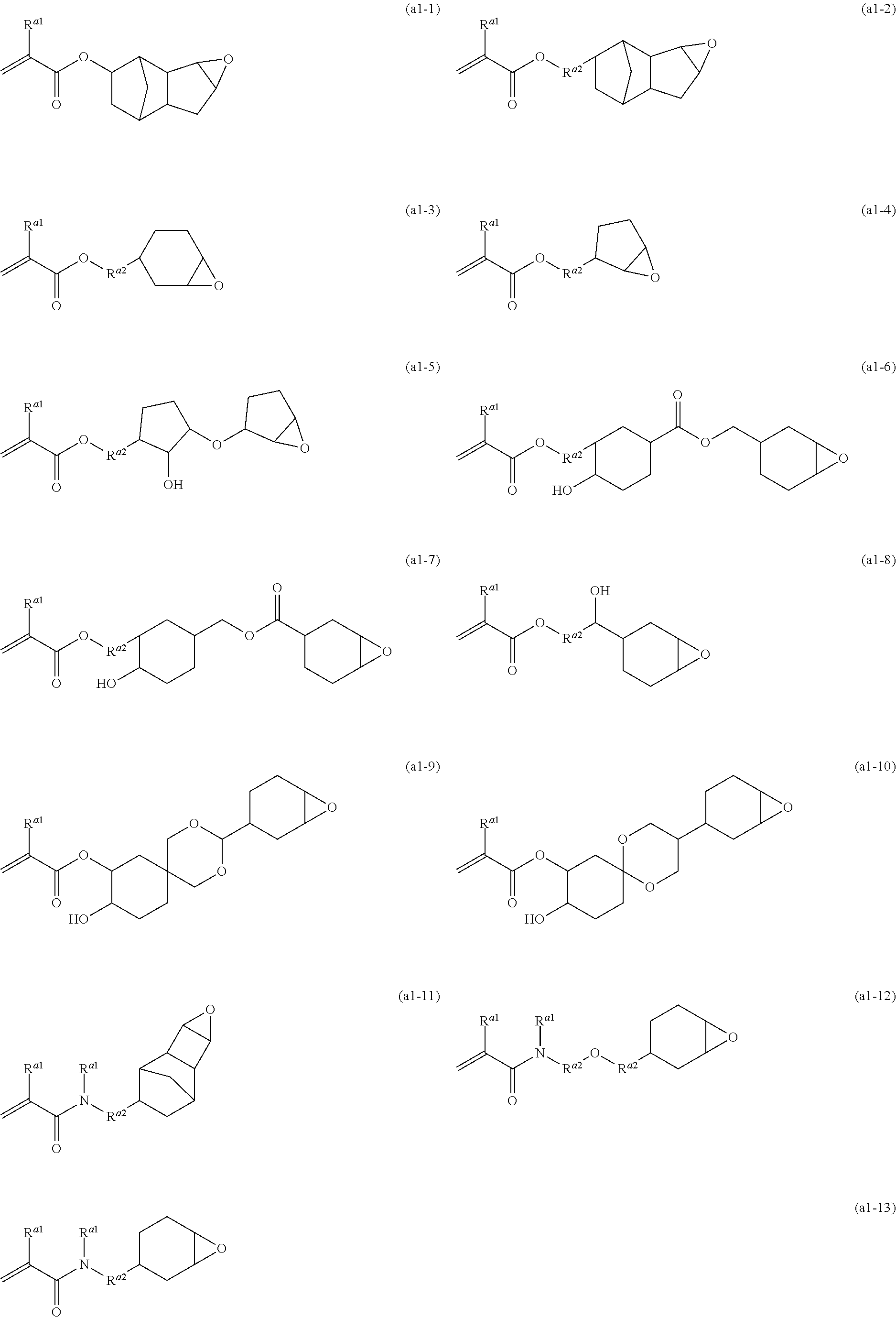

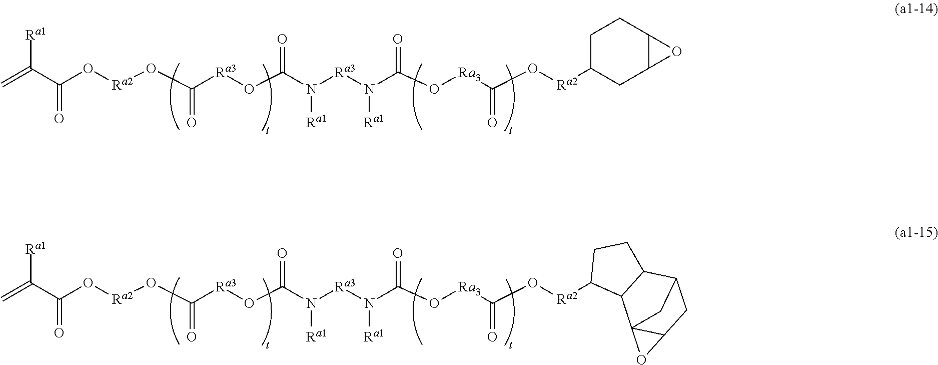

In the above formulae, R^{a1} is a hydrogen atom or a methyl group; R^{a2} is a divalent aliphatic saturated hydrocarbon group having 1 or more and 6 or less carbon atoms; R^{a3} is a divalent hydrocarbon group having 1 or more and 10 or less carbon atoms; and t represents an integer of 0 or more and 10 or less. R^{a2} is a linear or branched alkylene group and is preferably, for example, a methylene group, an ethylene group, a propylene group, a tetramethylene group, an ethylethylene group, a pentamethylene group, or a hexamethylene group. R^{a3} is preferably, for example, a methylene group, an ethylene group, a propylene group, a tetramethylene group, an ethylethylene group, a pentamethylene group, a hexamethylene group, a phenylene group, or a cyclohexylene group.

The amount of the structural unit A1 in the (A) resin is not particularly limited within a range where the object of the present invention is not impaired. The content of the structural unit A1 in the (A) resin is, for example, 20% by mole or more, preferably 20% by mole or more and 95% by mole or less, more preferably 30% by mole or more and 90% by mole or less, and further preferably 50% by mole or more and 85% by mole or less with respect to total structural units of the resin, from the viewpoint of curability. Specifically, when the structural unit A1 is derived from an aliphatic (meth)acrylic acid ester having a chain aliphatic epoxy group, the content of the structural unit A1 in the (A) resin is, for example, 30% by mole or more, preferably 30% by mole or more and 95% by mole or less, further preferably 40% by mole or more and 90% by mole or less, and even further preferably 60% by mole or more and 90% by mole or less with respect to the total structural units of the resin, from the viewpoint of curability. Furthermore, when the structural unit A1 is derived from aliphatic (meth)acrylic acid ester having an alicyclic epoxy group, the content of the structural unit A1 in the (A) resin is, for example, 30% by mole or more, preferably 30% by mole or more and 95% by mole or less, more preferably 40% by mole or more and 90% by mole or less, and further preferably 50% by mole or more and 80% by mole or less with respect to the total structural units of the resin, from the viewpoint of curability.

### <Structural Unit A2>

A structural unit A2 is a structural unit represented by the formula (a2).

In the formula (a2), R⁴ is a divalent hydrocarbon group. The hydrocarbon group as R⁴ may be an aliphatic hydrocarbon group, or an aromatic hydrocarbon group, or a hydrocarbon group having an aliphatic moiety and an aromatic moiety. From the viewpoint of curability of resin, R⁴ is preferably a divalent aliphatic hydrocarbon group. When R⁴ is a divalent aliphatic hydrocarbon group, the structure of the aliphatic hydrocarbon group may be linear or branched, or cyclic, or a combination thereof, and the structure is preferably linear.

The number of carbon atoms of the hydrocarbon group as R⁴ is not particularly limited. When the hydrocarbon group is an aliphatic hydrocarbon group, the number of carbon atoms is preferably 1 or more and 20 or less, more preferably 2 or more and 10 or less, and particularly preferably 2 or more and 6 or less. When the hydrocarbon group is an aromatic group or a hydrocarbon group having an aliphatic moiety and an aromatic moiety, the number of carbon atoms is preferably 6 or more and 20 or less, and more preferably 6 or more and 12 or less.

Specific examples of the divalent aliphatic hydrocarbon group include linear or branched alkyl groups such as a methylene group, an ethane-1,2-diyl group, an ethane-1,1-diyl group, a propane-1,3-diyl group, a propane-1,2-diyl group, a butane-1,4-diyl group, a pentane-1,5-diyl group, a hexane-1,6-diyl group, a heptane-1,7-diyl group, an octane-1,8-diyl group, a nonane-1,9-diyl group, a decane-1,10-diyl group, a undecane-1,11-diyl group, a dodecane-1,12-diyl group, a tridecane-1,13-diyl group, a tetradecane-1,14-diyl group, a pentadecane-1,15-diyl group, a hexadecane-1,16-diyl group), a heptadecane-1,17-diyl group, an octadecane-1,18-diyl group, a nonadecane-1,19-diyl group, and a icosane-1,20-diyl group. Among these, a methylene group, an ethane-1,2-diyl group, a propane-1,3-diyl group, a butane-1,4-diyl group, a pentane-1,5-diyl group, a hexane-1,6-diyl group, a heptane-1,7-diyl group, an octane-1,8-diyl group, a nonane-1,9-diyl group, a decane-1,10-diyl group, an undecane-1,11-diyl group, a dodecane-1,12-diyl group, a tridecane-1,13-diyl group, a tetradecane-1,14-diyl group, a pentadecane-1,15-diyl group, a hexadecane-1,16-diyl group, a heptadecane-1,17-diyl group, an octadecane-1,18-diyl group, a nonadecane-1,19-diyl group, and an icosane-1,20-diyl group are preferable, a methylene group, an ethane-1,2-diyl group, a propane-1,3-diyl group, a butane-1,4-diyl group, a pentane-1,5-diyl group, a hexane-1,6-diyl group, a heptane-1,7-diyl group, an octane-1,8-diyl group, a nonane-1,9-diyl group, and a decane-1,10-diyl group are more preferable, and an ethane-1,2-diyl group, a propane-1,3-diyl group, a butane-1,4-diyl group, a pentane-1,5-diyl group, and a hexane-1,6-diyl group are further preferable.

Specific examples of the divalent aromatic hydrocarbon group include phenylene groups such as a p-phenylene group, an m-phenylene group, and an o-phenylene group, a naphthalene-1,4-diyl group, a naphthalene-2,6-diyl group, and a naphthalene-2,7-diyl group; and a p-phenylene group and an m-phenylene group are preferable, and a p-phenylene group is more preferable.

The structural unit A2 is incorporated into a resin by copolymerizing (meth)acrylic acid ester represented by the following formula (a-II) with a monomer giving the other structural unit. The structural unit A2 may be present in the resin in a block state or may be at random.

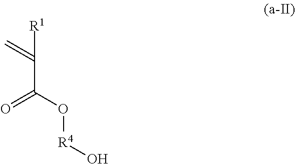

(In the formula (a-II), R¹ and R⁴ are the same as those in the formula (a2)

Specific suitable examples of the (meth)acrylic acid ester giving a structural unit A2 include 2-hydroxyethyl acrylate, 2-hydroxyethyl methacrylate, 3-hydroxy propyl acrylate, 3-hydroxy propyl methacrylate, 4-hydroxy butyl acrylate, 4-hydroxy butyl methacrylate, 4-hydroxyphenyl acrylate, 4-hydroxyphenyl methacrylate, 3-hydroxyphenyl acrylate, 3-hydroxyphenyl methacrylate, and the like. Among them, 2-hydroxyethyl acrylate, 2-hydroxyethyl methacrylate, 4-hydroxyphenyl acrylate, and 4-hydroxyphenyl methacrylate are preferable.

The amount of the structural unit A2 in the (A) resin is not particularly limited within a range where the object of the present invention is not impaired. The content of the structural unit A2 in the (A) resin is preferably 3% by mole or more and 40% by mole or less, more preferably 5% by mole or more and 30% by mole or less, and further preferably 10% by mole or more and 25% by mole or less with respect to the total structural units, from the viewpoint of curability.

### <Other Structural Units>

The (A) resin may be made of only the above-described structural unit A1 and structural unit A2, but also may include other structural units outside of the above-described structural unit A1 and structural unit A2 within a range where the object of the present invention is not impaired.

Examples of the other structural units include a structural unit derived from (meth)acrylic acid ester other than the above. Such (meth)acrylic acid ester is not particularly limited as long as it is represented by the following formula (a-III) and does not impair the object of the present invention.

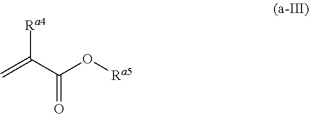

In the above formula (a-III), R^{a4} is a hydrogen atom or a methyl group. R^{a5} is an organic group not having a group including active hydrogen. Examples of groups including an active hydrogen include a hydroxyl group, a mercapto group, an amino group, a carboxy group, and the like. This organic group may include a bond or a substituent other than a hydrocarbon group, such as a hetero atom in the organic group, and the like. Furthermore, this organic group may be linear, branched, or cyclic.

The substituent other than the hydrocarbon group in the organic group of R^{a5} is not particularly limited as long as effects of the present invention are not impaired, and examples thereof include a halogen atom, an alkylthio group, an arylthio group, a cyano group, a silyl group, an alkoxy group, alkoxycarbonyl group, a nitro group, a nitroso group, an acyl group, an acyloxy group, an alkoxyalkyl group, an alkylthio alkyl group, an aryloxy alkyl group, an arylthio alkyl group, an N,N-disubstituted amino group (—NRR′: R and R′ each independently represents a hydrocarbon group), and the like. The hydrogen atom included in the above substituent may be substituted with a hydrocarbon group. Furthermore, the hydrocarbon group included in the above substituent may be either linear, branched, or cyclic.

As R^{a5}, an alkyl group, an aryl group, an aralkyl group, or a heterocyclic group is preferable. These groups may be substituted with a halogen atom, an alkyl group, or a heterocyclic group. Furthermore, when these groups include an alkylene moiety, the alkylene moiety may be interrupted by an ether bond, a thioether bond, or an ester bond.

When the alkyl group is linear or branched, the number of carbon atoms is preferably 1 or more and 20 or less, more preferably 1 or more and 15 or less, and particularly preferably 1 or more and 10 or less. Suitable examples of the alkyl group include a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an n-heptyl group, an n-octyl group, an isooctyl group, a sec-octyl group, a tert-octyl group, an n-nonyl group, an isononyl group, an n-decyl group, an isodecyl group, and the like.

When R^{a5} is an alicyclic group, or a group including an alicyclic group, examples of the suitable alicyclic group include monocyclic alicyclic groups such as a cyclopentyl group and a cyclohexyl group; and polycyclic alicyclic groups such as an adamanthyl group, a norbornyl group, an isobornyl group, a tricyclononyl group, a tricyclodecyl group, and a tetracyclo dodecyl group.

Examples of monomers other than the above (meth)acrylic acid ester giving the other structural unit include an allyl compound, vinyl ethers, vinyl esters, styrenes, and the like. These monomers can be used singly or in a combination thereof of 2 or more.

Examples of the allyl compound include allyl esters such as allyl acetate, allyl caproate, allyl caprylate, allyl laurate, allyl palmitate, allyl stearate, allyl benzoate, allyl acetoacetate and allyl lactate; and allyloxyethanol and the like.

Examples of the vinyl ethers include an alkyl vinyl ether such as hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, diethylene glycol vinyl ether, dimethylaminoethyl vinyl ether, diethylaminoethyl vinyl ether, butylaminoethyl vinyl ether, benzyl vinyl ether or tetrahydrofurfuryl vinyl ether; and a vinyl aryl ether such as vinyl phenyl ether, vinyl tolyl ether, vinyl chlorophenyl ether, vinyl-2,4-dichlorophenyl ether, vinyl naphthyl ether or vinyl anthranyl ether.

Examples of the vinyl esters include vinyl butyrate, vinyl isobutyrate, vinyl trimethyl acetate, vinyl diethyl acetate, vinyl valate, vinyl caproate, vinyl chloroacetate, vinyl dichloroacetate, vinyl methoxyacetate, vinyl butoxyacetate, vinyl phenyl acetate, vinyl acetoacetate, vinyl lactate, vinyl-β-phenyl butyrate, vinyl benzoate, vinyl chlorobenzoate, vinyl tetrachlorobenzoate and vinyl naphthoate.

Examples of the styrenes include styrene; an alkyl styrene such as methylstyrene, dimethylstyrene, trimethylstyrene, ethylstyrene, diethylstyrene, ispropylstyrene, butylstyrene, hexylstyrene, cyclohexylstyrene, decylstyrene, benzylstyrene, chloromethylstyrene, trifluoromethylstyrene, ethoxymethylstyrene or acetoxymethylstyrene; an alkoxystyrene such as methoxystyrene, 4-methoxy-3-methylstyrene or dimethoxystyrene; and a halostyrene such as chlorostyrene, dichlorostyrene, trichlorostyrene, tetrachlorostyrene, pentachlorostyrene, bromostyrene, dibromostyrene, iodostyrene, fluorostyrene, trifluorostyrene, 2-bromo-4-trifluoromethylstyrene, 4-fluoro-3-trifluoromethylstyrene, and the like.

When the (A) resin includes other structural units outside of the above-described structural unit A1 and structural unit A2, the total amount of the structural unit A1 and the structural unit A2 in the (A) resin is preferably 80% by mole or more, more preferably 90% by mole or more, and particularly preferably 95% by mole or more with respect to the total structural units in the (A) resin.

### <Method for Producing (A) Resin>

The method for producing the (A) resin described above is not particularly limited. In general, the (A) resin is obtained by mixing predetermined amounts of monomers giving the above-described structural unit A1 and structural unit A2 and monomers giving other structural units as necessary, and subjecting the resultant mixture to polymerization in an appropriate solvent in the presence of a polymerization initiator, for example, in a temperature range of 50° C. or more and 120° C. or less. The (A) resin is often obtained in the form of solution with an organic solvent, but the (A) resin obtained as a solution may be blended as it is in the below-mentioned curable resin composition, or the (A) resin once precipitated as a solid polymer may be blended in a curable resin composition.

The weight-average molecular weight of the (A) resin obtained by the above method is preferably 5000 or more, further preferably 7500 or more and 100000 or less, and particularly preferably 10000 or more and 80000 or less. The weight-average molecular weight is a molecular weight based on polystyrene measured by GPC. When the weight-average molecular weight of the resin is large to some extent, a cured product having excellent solvent resistance or thermal decomposition resistance can be easily formed.

The content of the (A) resin is set to be preferably 20% by mass or more and 90% by mass or less, more preferably 30% by mass or more and 85% by mass or less, and particularly preferably 40% by mass or more and 80% by mass or less based on the total solid content of the composition. When the content is set to such a range as mentioned above, it is easy to obtain a cured product having excellent solvent resistance.

### <<(B) Hollow Particles>>

Each of the (B) hollow particles included in the curable resin composition of this embodiment have a shell portion made of resin.

The (B) hollow particles include a shell portion as an outer coat and an air gap inside. The shell portion may be a single layer or a plurality of layers. When the shell portion includes a plurality of layers, each of the layers may be made of different resin components. Furthermore, the (B) hollow particles may be subjected to surface treatment by well-known techniques in order to enhance the affinity with the (A) resin and the like described above.

Specific examples of the (B) hollow particles include polyester porous particles and acrylic porous particles obtained by subjecting a W/O/W emulsion to suspension-polymerization, styrene-acrylic hollow latex made by seed polymerization, vinylidene chloride-acrylonitrile and acrylonitrile thermally expandable microcapsules, and the like. Furthermore, hollow particles disclosed in Patent Documents 3 and 4 described above can be suitably used. Examples of commercially available hollow particles include Techpolymer (registered trademark) NH (manufactured by Sekisui Plastics Co., Ltd.), and the like.

The average particle diameter of the (B) hollow particles can be appropriately set depending on the applications of use of the curable resin composition, and the average particle diameter is, for example, in a range of 20 nm or more and 300 nm or less, preferably in a range of 30 nm or more and 200 nm or less, further preferably in a range of 50 nm or more and 150 nm or less, and particularly preferably in a range of 60 nm or more and 100 nm or less. The thickness of the shell layer of the (B) hollow particles is, for example, set to a range of 0.03×X or more and 0.60×X or less, preferably set to a range of 0.05×X or more and 0.50×X or less, and more preferably set to a range of 0.10×X or more and 0.40×X or less, where the average particle diameter of the (B) hollow particles is X [nm]. More typically, it is preferable that the average particle diameter of the (B) hollow particles is set to a range of 50 nm or more and 150 nm or less, and the thickness of the shell layer of the (B) hollow particles is set to a range of 5 nm or more and 30 nm or less. When they are set in such ranges, it is possible to balance the mechanical strength when the curable resin composition is cured and a low refractive index. Note here that the average particle diameter of the (B) hollow particles can be measured using, for example, a dynamic light scattering method. The thickness of the shell layer of the (B) hollow particles can be measured by observing the cross sections of 50 particles selected at random.

The content of the (B) hollow particles is preferably 10% by mass or more and 80% by mass or less, more preferably 15% by mass or more and 70% by mass or less, further preferably 20% by mass or more and 60% by mass or less, particularly preferably 30% by mass or more and 60% by mass or less, and very preferably 40% by mass or more and 60% by mass or less based on the total solid content of the composition. When the content is set in such a range, a cured product having excellent solvent resistance is easily obtained.

### <<(S) Organic Solvent>>

The curable resin composition of this embodiment includes an (S) organic solvent. Suitable examples of the (S) organic solvent include monoalkylethers of glycols, such as ethylene glycol monomethylether, ethylene glycol monoethylether, propylene glycol monomethylether, propylene glycol monoethylether, diethylene glycol monomethylether, diethylene glycol monoethylether, propylene glycol monopropylether, and propylene glycol monobutylether; monoalkylether acetates of glycols, such as ethylene glycol monomethylether acetate, ethylene glycol monoethylether acetate, propylene glycol monomethylether acetate, propylene glycol monoethylether acetate, propylene glycol monopropylether acetate, and propylene glycol monobutylether acetate; aromatic solvents such as toluene and xylene; ketones such as acetone, methyl ethyl ketone, 2-heptanone, cyclopentanone, and cyclohexanone; esters such as ethyl acetate, butyl acetate, ethyl ethoxyacetate, ethyl hydroxy acetate, 3-methoxybutyl acetate, 3-methyl-3-methoxybutyl acetate, ethyl 2-hydroxypropionate, ethyl 2-hydroxy-2-methylpropionate, methyl 2-hydroxy-3-methylbutanoate, methyl 3-methoxypropionate, ethyl 3-methoxypropionate, ethyl 3-ethoxypropionate, methyl 3-ethoxypropionate, methyl pyruvate, ethyl lactate, butyl lactate, and γ-butyrolactone.

Among these (S) organic solvents, from the viewpoint of leveling characteristics of a coating film when a curable resin composition is applied, propylene glycol monomethyl ether, propylene glycol monomethyl ether acetate, 2-heptanone, cyclopentanone, cyclohexanone, ethyl lactate, and butyl lactate are preferable, propylene glycol monomethyl ether, propylene glycol monomethyl ether acetate, 2-heptanone, cyclopentanone, and cyclohexanone are more preferable. The (S) organic solvent included in the curable resin composition may be included alone, or may be a combination of a plurality of types.

The used amount of the (S) organic solvent in the curable resin composition is not particularly limited and is appropriately determined in accordance with the application of use of the curable resin composition in consideration of the viscosity and the like. The used amount of the (S) organic solvent is set such that the solid content concentration in the curable resin composition is preferably 1% by mass or more, more preferably 2% by mass or more, and further preferably 3% by mass or more. Furthermore, the used amount of the (S) organic solvent is set such that the solid content concentration in the curable resin composition is preferably 45% by mass or less, more preferably 30% by mass or less, further preferably 25% by mass or less, and particularly preferably 15% by mass or less.

Hereinafter, components capable of being included as optional components in the curable resin composition are described.

### <<(C) Epoxy Compound>>

The curable resin composition of this embodiment may include a (C) epoxy compound. Note here that the (C) epoxy compound herein does not correspond to the above-described component (A).

As the (C) epoxy compound, various conventionally widely known epoxy compounds can be used. The molecular weight of such epoxy compounds is not particularly limited. Among the epoxy compounds, because a cured film having excellent heat resistance, chemical resistance, an excellent mechanical property, and the like, can be easily formed, a polyfunctional epoxy compound having two or more epoxy groups in a molecule is preferable.

The polyfunctional epoxy compound is not particularly limited as long as it is a di- or more functional epoxy compound. Examples of polyfunctional epoxy compounds include difunctional epoxy resins such as bisphenol A type epoxy resin, bisphenol F type epoxy resin, bisphenol S type epoxy resin, bisphenol AD type epoxy resin, naphthalene type epoxy resin, and biphenyl type epoxy resin; glycidyl ester type epoxy resins such as dimer acid glycidyl ester and triglycidyl ester; glycidyl amine type epoxy resins such as tetraglycidyl aminodiphenylmethane, triglycidyl-p-aminophenol, tetraglycidyl metaxylylenediamine, and tetraglycidyl bisaminomethylcyclohexane; heterocyclic epoxy resin such as triglycidyl isocyanurate; trifunctional epoxy resins such as phloroglucinol triglycidylether, trihydroxybiphenyl triglycidylether, trihydroxyphenylmethane triglycidylether, glycerin triglycidylether, 2-[4-(2,3-epoxypropoxy)phenyl-2-[4-[1,1-bis[4-(2,3-epoxypropxy)phenyl]ethyl]phenyl]propane, and 1,3-bis[4-[1-[4-(2,3-epoxypropoxy)phenyl]-1-[4-[1-[4-(2,3-epoxypropoxy)phenyl]-1-methylethyl]phenyl]ethyl]phenoxy]-2-propanol; and tetrafunctional epoxy resins such as tetrahydroxyphenylethane tetraglycidylether, tetraglycidyl benzophenone, bisresorcinol tetraglycidylether, and tetraglycidoxybiphenyl.

Furthermore, an alicyclic epoxy compound is also preferable as the polyfunctional epoxy compound, from the viewpoint of providing a cured product having high hardness. Specific examples of the aliphatic epoxy compound include 2-(3,4-epoxycyclohexyl-5,5-spiro-3,4-epoxy)cyclohexane-meta-dioxane, bis(3,4-epoxycyclohexylmethyl)adipate, bis(3,4-epoxy-6-methylcyclohexylmethyl)adipate, 3,4-epoxy-6-methylcyclohexyl-3′,4′-epoxy-6′-methylcyclohexane carboxylate, ε-caprolactone-modified 3,4-epoxycyclohexylmethyl-3′,4′-epoxycyclohexane carboxylate, trimethylcaprolactone-modified 3,4-epoxycyclohexylmethyl-3′,4′-epoxycyclohexane carboxylate, β-methyl-5-valerolactone-modified 3,4-epoxycyclohexylmethyl-3′,4′-epoxycyclohexane carboxylate, methylenebis(3,4-epoxycyclohexane), di(3,4-epoxycyclohexylmethyl)ether of ethylene glycol, ethylenebis(3,4-epoxycyclohexane carboxylate), dioctyl epoxycyclohexahydrophthalate, and di-2-ethylhexyl epoxycyclohexahydrophthalate, an epoxy resin having a tricyclodecene oxide group, and the like. When the curable resin composition includes the (C) epoxy compound, the content thereof is preferably 1 part by mass or more and 100 parts by mass or less, and further preferably 3 parts by mass or more and 50 parts by mass or less with respect to 100 parts by mass of the above (A) resin.

### <<(D) Surfactant>>

Examples of a surfactant include a fluorine atom-containing surfactant, a silicon atom-containing surfactant, and the like. As the fluorine atom-containing surfactant, a fluorine-based surfactant having an alkylene oxide chain is preferable, and a fluorine-based surfactant having an alkylene oxide chain having a fluorinated alkyl group at the terminal is more preferable. As the silicon atom-containing surfactant, a polysiloxane surfactant having an alkylene oxide chain is preferable. Specific suitable examples of the fluorine atom-containing surfactant include, for example, Polyfox series PF-636, PF-6320, PF-656, PF-6520 (all are trade names, manufactured by OMNOVA), and the like. Specific suitable examples of the silicon atom-containing surfactant include BYK-307, BYK-333, BYK-378 (all are trade names, manufactured by BYK-Chemie GmbH), and the like. When the curable resin composition includes a (D) surfactant, the content thereof is preferably 0.01 parts by mass or more and 1 part by mass or less, more preferably 0.03 parts by mass or more and 0.8 parts by mass or less, further preferably 0.4 parts by mass or more and 0.8 parts by mass or less, and particularly preferably 0.5 parts by mass or more and 0.8 parts by mass or less with respect to 100 parts by mass of the (A) resin.

The curable resin composition of this embodiment may further include various additives within a range where the object of the present invention is not impaired. Examples of the additives include crosslinking agents, ultraviolet absorbers, sensitizers, plasticizers, antioxidants, photostabilizers, adhesion auxiliary agents, acid generators, radical generators, and the like. Furthermore, the curable resin composition may include fillers (for example, non-hollow structured silica, hollow silica, and zirconium oxide) other than the (B) component.

### <<Preparation Method of Curable Resin Composition>>

The curable resin composition of this embodiment is prepared by mixing the above components by an ordinary method and stirring thereof. Examples of devices usable in mixing and stirring the above components include a dissolver, a homogenizer, a three-roll mill, and the like. The mixture obtained after homogeneously mixing the components may be further filtered using a mesh, a membrane filter, and the like.

### <<Cured Product>>

The above curable resin composition is converted into a cured product through a heating step. The refractive index of the cured product is preferably 1.50 or less, more preferably 1.48 or less, and further preferably 1.45 or less. The lower limit of the refractive index is not particularly limited, but it is, for example, 1.20 or more. The above cured product has high solvent resistance. Therefore, the cured product is suitably used for an application in which an adhesive agent including an organic solvent is used and an application in which a laminated material is produced by forming another layer on the cured product using varnish including an organic solvent. More specifically, when the cured product is immersed in acetone under conditions at room temperature (23° C.) for five minutes, the reduction amount of the thickness can be made to be 5% or less, and more preferably less than 5%. (As a typical example, when a coating film having a film thickness of 1 μm is formed with the above curable resin composition to produce a cured product, and the cured product is immersed in acetone under conditions at room temperature (23° C.) for five minutes, a reduction amount of the thickness of the cured film can be made to be 0.05 μm or less, and more preferably less than 0.05 μm)

### <<Method for Producing Cured Product>>

Hereinafter, a method for producing the above cured product is described. A method for producing a cured product includes:

a molding step of molding the above curable resin composition into a predetermined shape; and
a curing step of curing by heating the molded curable resin composition.

In the molding step, the shape after molding and the molding method are not particularly limited. Examples of the method for molding into a predetermined shape include a method of applying varnish-like curable resin composition on a base material to form a coating film, followed by removing a solvent from the coating film; and a method of filling a curable resin composition into a mold having a recess of a predetermined shape, and then removing a solvent from the composition in the mold, and the like.

The method of applying the varnish-like curable resin composition on the base material is not particularly limited. For example, a composition including the above resin can be applied onto a base material to have a predetermined film thickness to obtain a coating film using, for example, a contact transfer type coating device such as a roll coater, a reverse coater, a bar coater, and a slit coater, or a non-contact type coating device such as a spinner (a rotating application device), and a curtain flow coater.

After the curable resin composition is molded by the above methods, a solvent is removed by appropriately carrying out heat treatment (pre-bake (post-apply bake (PAB)) treatment) to obtain a desired shape. The pre-baking temperature is appropriately selected in consideration of the boiling point of the solvent, and the like. The pre-baking may be carried out at a low temperature under reduced pressure in order to prevent the resin from being cured before the solvent is sufficiently removed.

The pre-baking method is not particularly limited. Examples of the method include: (i) a method of drying using a hot plate at a temperature of 80° C. or more and 120° C. or less (preferably 85° C. or more and 100° C. or less, more preferably 85° C. or more and 95° C. or less) for 60 seconds or more and 120 seconds or less; (ii) a method of leaving at room temperature for several hours or more and several days or less; and (iii) a method of removing a solvent by placing the base material in a hot heater or an infrared ray heater for within a range of several tens of minutes or more and several hours or less so as to remove a solvent.

The above formed coating film is subjected to heating (post-baking) to form a cured product. The curing temperature is not particularly limited as long as curing of the resin satisfactorily proceeds, and thermal deformation or thermal decomposition of the cured product does not occur. The upper limit of the curing temperature is, for example, preferably 300° C. or less, and preferably 280° C. or less. The lower limit of the curing temperature is preferably 120° C. or more and more preferably 130° C. or more.

### <<Application of Use>>

By the above method, the above-described cured product is produced. A cured film including this cured product can be used as a material constituting an optical member because of its low refractive index. Furthermore, the cured film can be used as a light scattering material, a low reflection material, a heat insulating material, and the like, in addition to being used as an optical material. In particular, from the high solvent resistance of the cured product, the above cured film can suitably be used as layers constituting a laminate formed by a laminating process using varnish including an organic solvent.

### EXAMPLES

Hereinafter, the present invention is described in more detail by way of Examples, but the present invention is not limited to these Examples.

### Examples 1 to 4

In each example, as an (A) resin (component (A)), the following A-1, A-2 and A-3 were used.

A-1: An acrylic polymer (weight-average molecular weight: 15000) including 70% by mass of a unit derived from glycidyl methacrylate, and 30% by mass of a unit derived from 2-hydroxyethyl methacrylate
A-2: An acrylic polymer (weight-average molecular weight: 10000) including 80% by mass of a unit derived from glycidyl methacrylate, and 20% by mass of a unit derived from 4-hydroxyphenyl methacrylate
A-3: An acrylic polymer (weight-average molecular weight: 20000) including 60% by mass of a unit derived from 3,4-epoxycyclohexylmethyl methacrylate and 40% by mass of a unit derived from 4-hydroxyphenyl methacrylate

In each of the following examples, as (B) hollow particles (component (B)), “Techpolymer (registered trademark) NH (hollow particles having a shell with an average particle diameter of 80 nm made of resin)” manufactured by Sekisui Plastics Co., Ltd., were used.

In each example, as the (D) surfactant (component (D-1)), a fluorine-based surfactant (PF-656, manufactured by OMNOVA, molecular weight 1500) was used.

In each example, as the (S) organic solvent (component (S)), an organic solvent obtained by mixing the following S-1 and S-2 at a mass ratio of 9:1 was used.

S-1: propylene glycol monomethyl ether S-2: propylene glycol monomethyl ether acetate A curable resin composition was prepared by dissolving and dispersing the (A) resin, the (B) hollow particles, and the (D) surfactant in the amounts (part by mass) respectively described in Table 1 in the (S) organic solvent such that the solid content concentration became 5% by mass.

### [Evaluation]

For the obtained curable resin composition, the solvent resistance and the refractive index of the cured product were measured as follows. The results thereof are shown in Table 1.

### (Solvent Resistance Test)

The curable resin composition of each example was applied on a silicon wafer by spin coating, and dried using a hot plate under pre-baking conditions at 90° C. for 90 seconds to form a resin layer having a film thickness of 1 μm. Thereafter, heating and curing were carried out using a hot plate under conditions at 200° C. for 5 minutes. The resultant cured film was subjected to a test of immersion in acetone under conditions at room temperature (23° C.) for 5 minutes.

The change in film thickness before and after the immersion in acetone was measured, and a case where the film thickness became 95% or more with respect to the film thickness before the immersion in acetone was evaluated as “∘”, and a case where it became less than 95% was evaluated as “x”. The results are shown in Table 1.

### (Refractive Index)

A cured film was obtained under the conditions as in the above-described items (solvent resistance test), and the refractive index of the obtained cured film at a wavelength of 550 nm was measured using a spectroscopic ellipsometer (VUV-VASE VU302 manufactured by J.A. Woollam). The results are shown in Table 1.

TABLE 1

| | | Example | Example | Example | Example |
|---|---|---|---|---|---|
| | | 1 | 2 | 3 | 4 |
| Composition | A-1 | 60 | | | |
| (Solid content) | A-2 | | 60 | 40 | |
| | A-3 | | | | 70 |
| | B | 39.7 | 39.7 | 59.7 | 29.7 |
| | D-1 | 0.3 | 0.3 | 0.3 | 0.3 |
| Evaluation | Solvent | 0 | 0 | 0 | 0 |
| | resistance test | | | | |
| | Refractive index | 1.41 | 1.41 | 1.36 | 1.45 |

The results prove that the curable resin composition of this Example can achieve a low refractive material having high solvent resistance.

What is claimed is:

1. A curable resin composition comprising:
a resin comprising a structural unit represented by the following formula (a1) and a structural unit represented by the following formula (a2);
hollow particles comprising a shell portion made of a resin; and
an organic solvent. 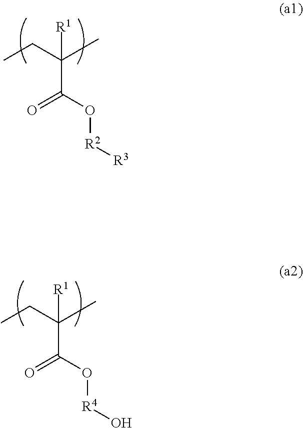
wherein each R¹ is independently a hydrogen atom or a methyl group; R² is a single bond or an alkylene group having 1 or more and 5 or less carbon atoms; R³ is a monovalent organic group having 2 or more and 30 or less carbon atoms and includes an epoxy group; and R⁴ is a divalent hydrocarbon group.

2. The curable resin composition according to claim 1, wherein the hollow particles have an average particle diameter of 20 nm or more and 300 nm or less.

3. The curable resin composition according to claim 1, wherein a content of the resin in a total solid content in the curable resin composition is 20% by mass or more and 90% by mass or less.

4. The curable resin composition according to claim 1, wherein a content of the hollow particles in the total solid content in the curable resin composition is 10% by mass or more and 80% by mass or less.

5. The curable resin composition according to claim 1, wherein a content of the structural unit represented by the formula (a1) with respect to total structural units in the resin is 20% by mole or more.

6. The curable resin composition according to claim 1, wherein a content of the structural unit represented by the formula (a2) with respect to the total structural units of the resin is 3% by mole or more and 40% by mole or less.

7. A cured product obtained by curing the curable resin composition according to claim 1.

8. The cured product according to claim 7, wherein said cured product has a refractive index of 1.50 or less.
